(19) United States
(12) Patent Application Publication
(10) Pub. No.: US 2014/0044331 A1
(43) Pub. Date: Feb. 13, 2014

(54) SYSTEMS AND METHODS FOR DEMONSTRATION IMAGE LIBRARY CREATION

(71) Applicants: Teri Lynn Fischer, Waukesha, WI (US); Romain Xavier Areste, Milwaukee, WI (US); Daniel Pol Mabini, Waukesha, WI (US); Vivek Walimbe, Pawaukee, WI (US)

(72) Inventors: Teri Lynn Fischer, Waukesha, WI (US); Romain Xavier Areste, Milwaukee, WI (US); Daniel Pol Mabini, Waukesha, WI (US); Vivek Walimbe, Pawaukee, WI (US)

(73) Assignee: GENERAL ELECTRIC COMPANY, Schenectady, NY (US)

(21) Appl. No.: 13/568,855

(22) Filed: Aug. 7, 2012

(51) Int. Cl. G06K 9/78

(52) U.S. Cl. 382/131

(57) ABSTRACT

A medical imaging demonstration image library creation method is provided. The method includes receiving data corresponding to a user acquired image of a subject obtained via operation of an X-ray imaging system and further receiving input from a user identifying the user acquired image of the subject as a desired demonstration image. The method also includes adding the user acquired image of the subject to a demonstration image library as a first demonstration image.

### BACKGROUND OF THE INVENTION

The subject matter disclosed herein generally relates to medical imaging systems and, more particularly, to systems and methods for the creation of a demonstration image library.

A wide range of tissues may be imaged through the use of various types of medical imaging systems. Many different types of imaging systems have been developed and refined, including X-ray systems, which have moved from film-based systems to digital X-ray. These digital X-ray systems are widely employed in medical environments, such as hospitals, to acquire image data corresponding to a region of interest in a patient. Once acquired, this image data is typically transferred to an operator workstation, and a medical operator (e.g., a radiologist, medical technician, nurse, etc.) may manipulate the acquired data for viewing and/or printing.

In many applications, it is desirable for the medical operator to transfer the obtained image data, or portions of the image data, to a hospital network component, such as a picture archiving communication system (PACS), for viewing and/or archiving. However, prior to transfer of the image data to PACS, image characteristics of a demonstration image may be applied to the image data. In many systems, a user chooses a desired demonstration image from a demonstration image library provided by the manufacturer of the imaging system. Unfortunately, the demonstration images provided by the manufacturer may not take into account factors such as the desired radiation dose associated with a particular imaging site, a condition of the imaged patient, and so forth. Accordingly, when the image characteristics of the chosen demonstration image are applied to the acquired image data and subsequently sent to PACS for review, the desired image appearance and quality is often not readily achieved, thus rendering the image transfer process inefficient. Accordingly, there exists a need for systems and methods that address these drawbacks.

### BRIEF DESCRIPTION OF THE INVENTION

In one embodiment, a medical imaging demonstration image library creation method is provided. The method includes receiving data corresponding to a user acquired image of a subject obtained via operation of an X-ray radiography based imaging system and further receiving input from a user identifying the user acquired image of the subject as a desired demonstration image. The method also includes adding the user acquired image of the subject to a demonstration image library as a first demonstration image.

In another embodiment, a medical imaging system includes an imager adapted to acquire image data indicative of a region of interest in a subject and an operator interface adapted to receive a user selection corresponding to an image of the subject acquired with the imager and desired as a demonstration image. The system also includes control circuitry communicatively coupled to the operator interface and the imager. The control circuitry is adapted to receive data corresponding to the image of the subject selected by the user and to add the user acquired image of the subject to a demonstration image library as a first demonstration image.

In another embodiment, a medical imaging system includes an operator interface that receives a user selection corresponding to a user acquired image of a subject obtained via operation of an X-ray radiography based imaging system and desired as a demonstration image. Control circuitry is communicatively coupled to the operator interface to receive data corresponding to the image of the subject selected by the user. In operation, the control circuitry adds the user acquired image of the subject to a demonstration image library as a first demonstration image. Further, a picture archiving communication system (PACS) is adapted to receive data corresponding to the first demonstration image and to display the first demonstration image.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an X-ray system operable in accordance with aspects of the present technique;

FIG. 2 is a block diagram of the X-ray system illustrated in FIG. 1 showing components included in an embodiment of the X-ray system;

FIG. 3 is a flow chart illustrating a method for customizing a demonstration image library in accordance with user preferences in accordance with an embodiment; and

FIG. 4 is a flow chart illustrating a method for creating a customized demonstration image library and utilizing the created library for image quality optimization in accordance with an embodiment.

### DETAILED DESCRIPTION OF THE INVENTION

As described in detail below, methods and systems are provided for the creation of a customized, user-defined demonstration image library for a medical imaging system. That is, the embodiments provided herein enable a user to incorporate user acquired images of a subject into the demonstration image library associated with the imaging system, thus reducing or eliminating the need for the user to utilize pre-loaded demonstration images provided by the manufacturer of the imaging system. The customized demonstration image library may be utilized by the user to format or modify subsequently acquired images prior to their transmission to a medical facility network component, such as a picture archiving communication system (PACS). The foregoing features may endow imaging systems with the ability to account for site-specific or user-specific preferences, thus increasing the efficiency of the use of such systems. For example, by enabling customization of the demonstration image library based on user acquired images obtained at the imaging site, site-specific factors, such as a site's desired dose, a patient's condition, and so forth, may be incorporated into the image processing system. In certain instances, the foregoing features may enable a desired image quality and format to be efficiently achieved for the images transmitted and displayed via PACS.

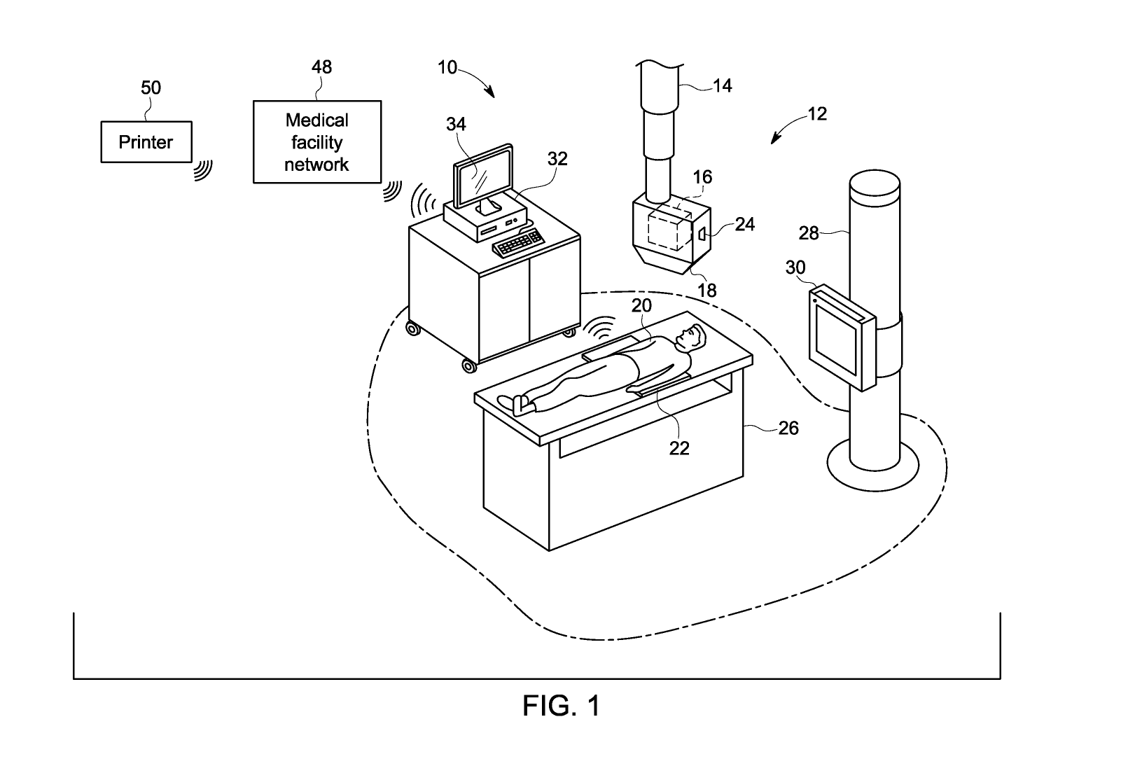

Turning now to the drawings, FIG. 1 illustrates an embodiment of an X-ray system 10 that is operable in accordance with presently disclosed techniques. In the depicted embodiment, the X-ray system 10 may be a digital or analog X-ray system. However, it should be noted that the demonstration image library creation methods disclosed herein may be utilized with a variety of types of X-ray image acquisition systems and are not limited to those illustrated. For example, the demonstration image library creation methods may be utilized with mobile or fixed radiography systems. For further example, the demonstration image library creation methods may be utilized with mobile or fixed fluoroscopy systems. Indeed, the foregoing methods may be utilized with any desired type of X-ray system. Still further, it should be noted that the images customized in the methods described herein may be single-shot radiographic (RAD) X-ray images, multi-frame fluoroscopy images, VolumeRAD (tomosynthesis) images, image pasting images, dual energy images, or any other type of images acquired from an X-ray imaging system.

The depicted X-ray system 10 is designed to acquire original images or image data and to process the image data for display (e.g., in a digital X-ray system) and/or printing. To that end, the X-ray system may utilize a demonstration image library for the initial formatting of the acquired image data. That is, one or more demonstration images included in the demonstration image library may have certain image characteristics that may be utilized to format the newly acquired images, thus endowing the newly acquired images with the same image characteristics as the chosen demonstration image. As described in more detail below, presently disclosed embodiments enable a user to add user-acquired images to the demonstration image library, thus expanding the demonstration image library to include demonstration images that are site specific, patient type specific, or otherwise customized as desired by the user. The foregoing feature may increase the efficiency of the review, display, and/or printing of the acquired images, as compared to systems in which the demonstration image library is limited to demonstration images (which may be phantom images) provided by the manufacturer.

The illustrated X-ray system 10 includes an imaging system 12. The imaging system 12 includes an overhead tube support arm 14 for positioning a radiation source 16, such as an X-ray tube, and a collimator 18 with respect to a patient 20 and an image receptor 22. In analog X-ray systems 10, the image receptor 22 may include a radiographic film and cassette, phosphorescent screen and computed radiography cassette, or other devices. In digital X-ray systems, the image receptor 22 may include a digital X-ray detector. The imaging system 12 may also include a camera 24 to help facilitate the positioning of the radiation source 16 and collimator 18.

Moreover, in one embodiment, the imaging system 12 may be used in combination with one or both of a patient table 26 and a wall stand 28 to facilitate image acquisition. Particularly, the table 26 and the wall stand 28 may be configured to receive image receptor 22. For instance, image receptor 22 may be placed on an upper, lower, or intermediate surface of the table 26, and the patient 20 (more specifically, a region of interest of the patient 20) may be positioned on the table 26 between the image receptor 22 and the radiation source 16. Also, the wall stand 28 may include a receiving structure 30 adapted to receive the image receptor 22, and the patient 20 may be positioned adjacent the wall stand 28 to enable the image or image data to be acquired via the image receptor 22. The receiving structure 30 may be moved vertically along the wall stand 28 in certain embodiments.

Also depicted in FIG. 1, the imaging system 12 includes a workstation 32 and display 34. In one embodiment, the workstation 32 may include or provide the functionality of the imaging system 12 such that a user, by interacting with the workstation 32, may control operation of the source 16 and detector 22 (in a digital X-ray system). For example, in some embodiments, the user may utilize the operator workstation 32 to prepare the imaging system 12 for an exposure and, subsequently, to initiate the exposure. For further example, an operator interface (e.g., displayed on display 34) of the workstation 32 may be configured to receive a user-input command for operation of the imaging system 12 (e.g., changing X-ray source settings or moving the receiving structure 30 along the wall stand 28) prior to initiation of an X-ray exposure sequence. Further, the workstation 32 may transmit the commands received via the operator interface shown on the display 34 to the imaging system 12 (e.g., via a wireless signal). In response to the received instructions, the imaging system 12 executes the commands and performs an imaging operation to acquire image data.

Once the data is acquired, the imaging system 12 is configured to communicate the image data corresponding to one or more regions of interest of the patient 20 to a variety of other suitable systems or devices, such as a medical facility network 48 and/or a printing device 50. The medical facility network 48 may include a hospital information system (HIS), a radiology information system (RIS), and/or a picture archiving communication system (PACS). However, in certain embodiments, prior to transmitting the image data, control circuitry disposed, for example, in the operator workstation 32 may be configured to receive the image data and execute one or more control algorithms, depending on operator inputs. For example, if the operator has indicated that a given set of image data is desired as a demonstration image, the control circuitry will add the user acquired image to the demonstration image library, which may be stored, for example, on memory associated with the control circuitry. For further example, if the operator has indicated that a demonstration image in the demonstration image library should be utilized to format the image data, the control circuitry may process the image data accordingly prior to transmitting the image data. These and other functionalities of the control circuitry are described in more detail below.

In some embodiments, the imaging system 12 may be a stationary system disposed in a fixed X-ray imaging room, such as that generally illustrated in FIG. 1. It will be appreciated, however, that the presently disclosed techniques may also be employed with other imaging systems, including mobile X-ray units and systems, in other embodiments. Indeed, in certain embodiments, a single workstation 32 may include control circuitry that receives image data from a variety of different types of imaging systems, such as digital radiography systems, analog radiography systems, fluoroscopy systems, or a combination thereof. As such, the control circuitry may be configured to process portions of data acquired from different modalities or in different formats in accordance with received or stored guidelines. As such, the X-ray imaging system 12 shown in FIG. 1 is merely an example, and the presently disclosed techniques are contemplated for use with a variety of suitable systems.

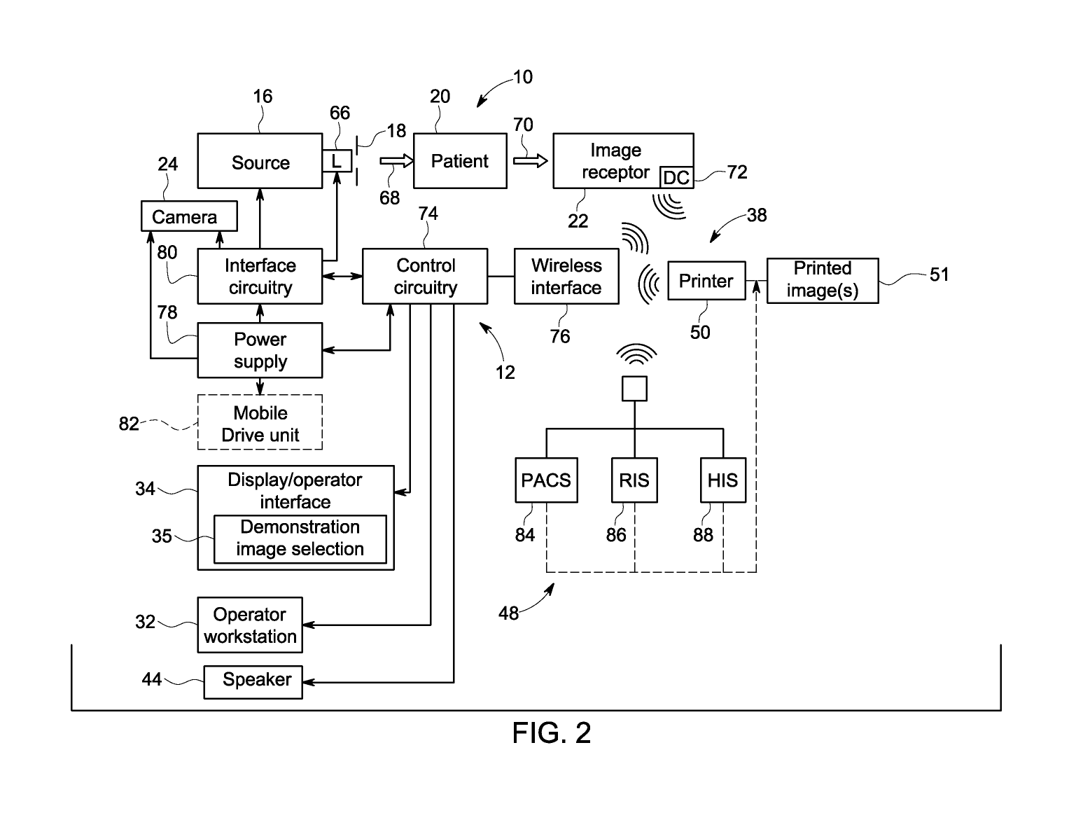

FIG. 2 is a diagrammatical illustration of components of an embodiment of the X-ray system 10 shown in FIG. 1. As illustrated in FIG. 2, the X-ray system 10 includes the source of X-ray radiation 16 positioned adjacent to the collimator 18. A light source 66, also known as a collimator light, is positioned between the X-ray source 16 and the collimator 18. The collimator 18 permits a stream of radiation 68 or light to be directed to a specific region in which an object or subject, such as the patient 20, is positioned. A portion 70 of the radiation passes through or around the subject and impacts the image receptor or digital X-ray detector 22. As will be appreciated by those skilled in the art, the detector 22 in digital X-ray systems 10 converts the X-ray photons received on its surface to lower energy photons, and, subsequently, to electric signals, which are acquired and processed to reconstruct an image of the features within the subject. The collimator light 66 in the collimator 18 directs light onto the same area where the X-ray photons will pass and can be used to position the patient 20 before exposure. The collimator light 66 can be turned on and off via a user input received through an operator interface displayed on the imaging system 12.

Moreover in digital X-ray systems, the detector 22 is coupled to a detector controller 72 which commands acquisition of the signals generated in the detector 22. The detector controller 72 may also execute various signal processing and filtration functions, such as for initial adjustment of dynamic ranges, interleaving of digital image data, and so forth. The detector controller 72 is responsive to signals from control circuitry 74 communicated wirelessly via a wireless interface 76. In general, the control circuitry 74 commands operation of the imaging system 12 to execute examination protocols and to process acquired image data. For example, the control circuitry 74 may apply the image characteristics of a user selected demonstration image to a newly acquired image. For further example, the control circuitry 74 may add a user acquired image to a stored demonstration image library when the user indicates that the acquired image is desired as a demonstration image. In the present context, the control circuitry 74 also includes signal processing circuitry, typically based upon a programmed general purpose or application-specific digital computer; and associated devices (e.g., non-transitory memory devices), such as optical memory devices, magnetic memory devices, or solid-state memory devices, for storing programs and routines executed by a processor of the computer to carry out various functionalities, as well as for storing configuration parameters and image data, interface circuits, and so forth.

In both digital and analog X-ray systems 10, the radiation source 16 is controlled by the control circuitry 74 via generation of signals corresponding to examination sequences. For example, the control circuitry 74 can inhibit the operation of the radiation source 16 if the correct examination conditions are not in place. In addition, the control circuitry 74 controls a power supply 78 that supplies power to the radiation source 16, light source 66, and camera 24, as well as to the control circuitry 74. Interface circuitry 80 facilitates the provision of power to the radiation source 16, light source 66, camera 24, and control circuitry 74. The power supply 78 also provides power to a mobile drive unit 82 (in mobile X-ray systems) to drive the movement of a wheeled base of the X-ray base station.

In the embodiment illustrated in FIG. 2, the control circuitry 74 is linked to at least one output device, such as the display or operator interface 34 having a demonstration image selection feature 35. The output device may include standard or special purpose computer monitors and associated processing circuitry that may, for example, operate to display the demonstration image selection option 35 to the operator once image data has been acquired or received. The demonstration image selection option 35 may enable the operator to instruct the associated processing circuitry to automatically add the acquired image data to the demonstration image library. Further, it should be noted that the operator interface 34 may also enable the operator to alter one or more image characteristics of the acquired image data before the data is added to the demonstration image library. Additionally, via the operator interface 34, the operator may choose which demonstration image in the demonstration image library should be utilized to format newly acquired images before such images are transmitted to a portion of the medical facility network 48.

Additionally, one or more operator workstations 32 (e.g., operator workstations corresponding to different X-ray and fluoroscopy systems) may be further linked in the system for outputting system parameters, requesting examinations, viewing images, exchanging demonstration image libraries, and so forth. In general, displays, printers, workstations, and similar devices supplied within the system may be local to the imaging components, or may be remote from these components, such as elsewhere within an institution or hospital, or in an entirely different location, linked to the imaging system 12 via one or more configurable networks, such as the Internet, virtual private networks, and so forth. In some embodiments, the control circuitry 74 may be linked in this manner to control circuitry associated with a second imaging system (or any desired quantity of imaging systems), and the control circuitry 74 may transmit the demonstration image library associated with the system 10 to the second imaging system. In such embodiments, the transmitted demonstration image library may include demonstration images corresponding to images acquired by the user on the system 10 and tagged as desired demonstration images by the user. Further, as shown, it should be noted that the control circuitry 74 may also be linked to a speaker 44, which may provide audible signals, such as locator signals or patient-audible commands, in certain embodiments.

Via the wireless interface 76, the imaging system 12 communicates wirelessly with one or more devices or systems. For example, in the illustrated embodiment, the wireless interface 76 enables communication with the medical facility network 48 and the printer 50 to generate printed images 51. As previously mentioned, the medical facility network 48 includes PACS 84, RIS 86, and/or HIS 88. In certain embodiments, the imaging system 12 may transmit subsets of the image data to the medical facility network 48 in an order that is determined by the control circuitry 74 in accordance with a predetermined set of guidelines. Further, the control circuitry 74 may automatically apply one or more image characteristics of a user designated demonstration image to the images of the patient's anatomy prior to transmission of such images to the medical facility network 48.

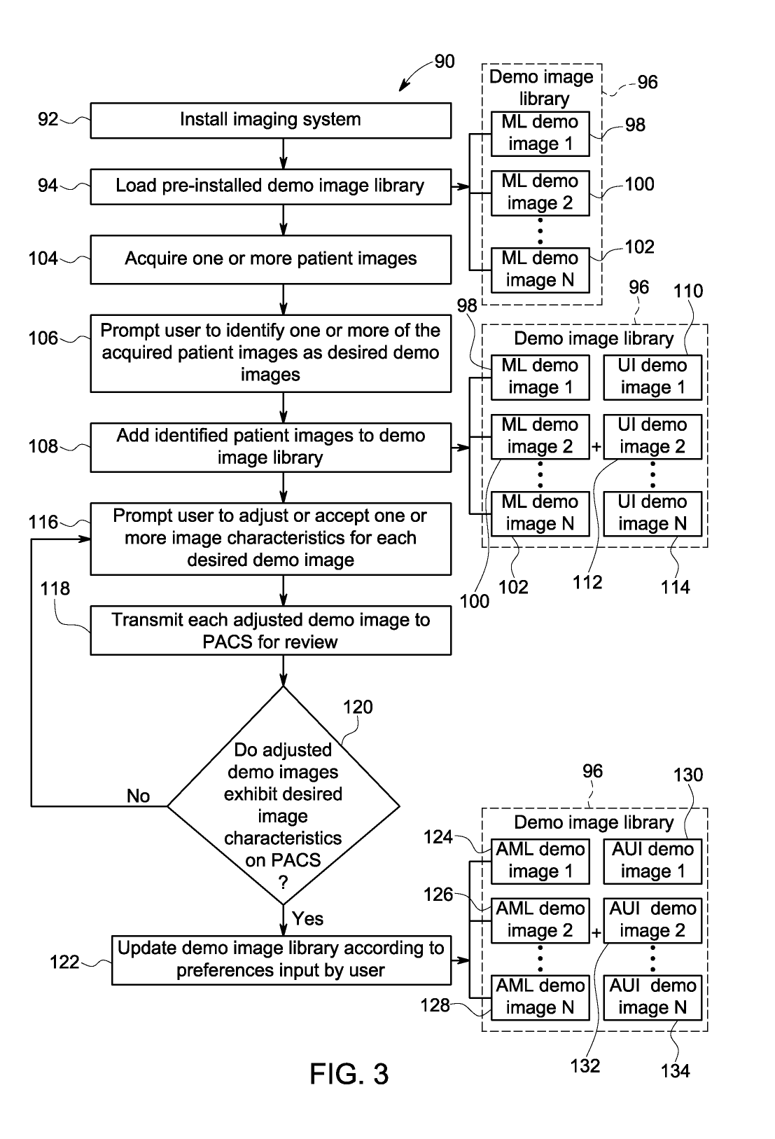

FIG. 3 is a flow chart illustrating a method 90 for customizing a demonstration image library in accordance with user preferences in accordance with a presently disclosed embodiment. As shown, the imaging system installation (block 92) at a particular site is followed by loading of a manufacturer provided demonstration image library (block 94). Once loaded, a demonstration image library 96 stored on the system includes, for example, a first manufacturer loaded demonstration image 98, a second manufacturer loaded demonstration image 100, and so forth, up to an N^{th} manufacturer loaded demonstration image, wherein N is any quantity of provided images.

However, it should be noted that in some embodiments, a manufacturer provided demonstration image library may not be loaded on the system, and the demonstration image library 96 may remain initially unpopulated. In these embodiments, the demonstration image library 96 may remain unpopulated until the user populates the library with one or more user acquired images. In other embodiments, however, the initial demonstration image library 96 may be imported from another imaging system and, thus, may include images acquired by an operator of another system, for example, at another location within a medical institution.

In the illustrated embodiment, once the demonstration image library 96 is populated with the manufacturer provided images 98, 100, and 102, one or more patient images are acquired by the user (block 104), for example, by operating the imaging system 12. The user is subsequently prompted to select one or more of the user acquired images for inclusion in the demonstration image library (block 106). For example, in one embodiment, each time an image is acquired, a button, such as demonstration image selection button 35, may be activated on the operator interface 34 that enables the user to tag the acquired image for inclusion in the demonstration image library.

In other embodiments, however, the manner in which the user may select images for inclusion in the demonstration image library may differ. For example, in certain embodiments, the features enabling the user to select desired demonstration images from a plurality of user acquired images may be embedded in one or more menus or submenus. Further, in some embodiments, the demonstration image selection functionality may be locked, and an administrator may have to unlock the functionality before a user may identify desired demonstration images. Indeed, it should be noted that the feature enabling selection of user acquired images for inclusion in the demonstration image library is subject to a variety of implementation-specific variations within the scope of the present disclosure, depending on the given application.

In the illustrated embodiment, once the user selects the images that are desired as demonstration images, the identified images are added to the demonstration image library 96 (block 108). Accordingly, the demonstration image library 96 is updated to include, for example, a first user identified demonstration image 110, a second user identified demonstration image 112, and so forth, up to an N^{th} user identified demonstration image 114. Once the desired user acquired demonstration images have been selected, the user may adjust one or more image characteristics of each of the selected images (block 116). It should be noted that the image characteristics available for adjustment may be implementation-specific, including characteristics such as, but not limited to, a contrast percentage, brightness percentage, tissue contrast parameter, edge parameter, a combination thereof, or any other desired image characteristics.

In the illustrated method 90, once adjusted in this manner, the adjusted (or accepted) demonstration images are transmitted to a medical facility component, such as PACS 84, for review (block 118). An inquiry is made as to whether or not the adjusted demonstration images exhibit the desired image characteristics on PACS (block 120), and if additional changes are desired, the demonstration images may be further adjusted. However, if the adjusted images are accepted, the demonstration image library 96 is updated (block 122) to include one or more adjusted images, which may include adjusted manufacturer provided images, adjusted user acquired and selected images, or a combination thereof For example, in the illustrated embodiment, a first adjusted manufacturer provided image 124, a second adjusted manufacturer provided image 126, and so forth, up to an N^{th} adjusted manufacturer provided image 128 are provided in the demonstration image library 96 along with a first adjusted user identified demonstration image 130, a second adjusted user identified demonstration image 132, and so forth, up to an N^{th} adjusted user identified demonstration image 134.

In this manner, presently disclosed embodiments may enable the demonstration image library 96 to include one or more user acquired images, either alone or in combination with one or more manufacturer provided images. The foregoing feature may endow imaging systems with the ability to account for site-specific or user-specific preferences, thus increasing the efficiency of the use of such systems. For example, by enabling customization of the demonstration image library based on user acquired images obtained at the imaging site, site-specific factors, such as a site's desired dose, a patient's condition, and so forth, may be incorporated into the image processing system. In certain instances, the foregoing features may enable a desired image quality and format to be efficiently achieved for the images transmitted and displayed via PACS.

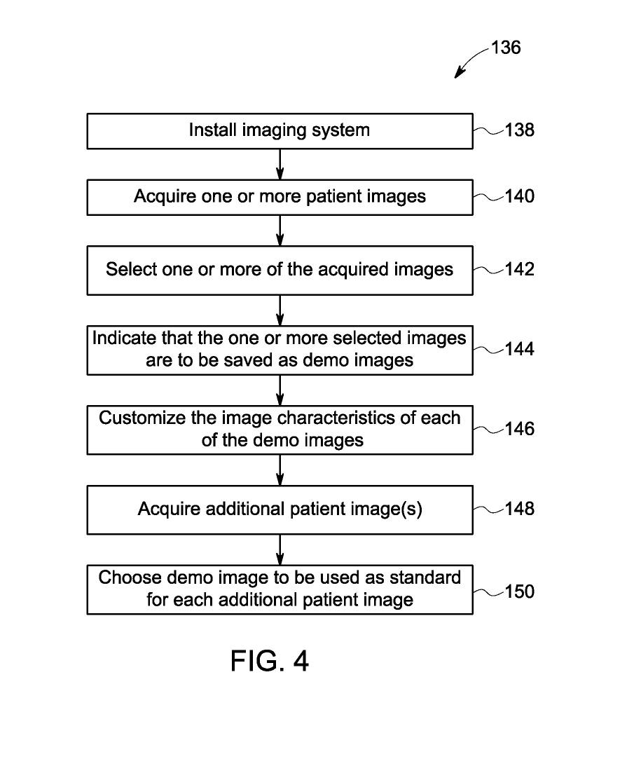

Still further, presently disclosed embodiments also provide for the use of a customized demonstration image library to achieve a desired image quality. For example, FIG. 4 illustrates a method 136 for creating a customized demonstration image library and utilizing the created library for image quality optimization in accordance with an embodiment. According to the illustrated method 136, the imaging system installation (block 138) at a particular site is followed by user acquisition of one or more patient images (block 140) and user selection of a subset of the acquired images (block 142). As before, once the user has indicated that the selected images are to be included in the demonstration image library (block 144), the user may customize the image characteristics of the selected images (block 146).

Once the customized demonstration image library has been created, for example, as described in detail in FIG. 3, the user may proceed to acquire additional patient images (block 148). For each additionally acquired image, the user may identify a demonstration image contained within the customized demonstration image library for use as a standard (block 150). The control circuitry 74 may then apply the image characteristics associated with the chosen demonstration image to the newly acquired image before transmitting the newly acquired image to the desired downstream component, such as PACS 84. Here again, it should be noted that in certain embodiments, by utilizing the customized demonstration image library, as opposed to, for example, a manufacturer provided library, a desired image quality and format may be efficiently achieved for the images transmitted and displayed via PACS.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A medical imaging demonstration image library creation method, comprising:
receiving data corresponding to a user acquired image of a subject obtained via operation of an X-ray imaging system;
receiving input from a user identifying the user acquired image of the subject as a desired demonstration image; and
adding the user acquired image of the subject to a demonstration image library as a first demonstration image.

2. The method of claim 1, comprising receiving user input corresponding to one or more desired image characteristics for the first demonstration image and replacing the first demonstration image in the demonstration image library with an adjusted demonstration image having the one or more desired image characteristics defined by the user.

3. The method of claim 2, comprising transmitting the adjusted demonstration image to a picture archiving communication system (PACS).

4. The method of claim 3, comprising receiving additional user input corresponding to one or more additionally desired image characteristics of the adjusted demonstration image, replacing the adjusted demonstration image in the demonstration image library with a twice adjusted demonstration image having the one or more additionally desired image characteristics defined by the user, and transmitting the twice adjusted demonstration image to the picture archiving communication system (PACS).

5. The method of claim 2, wherein the one or more desired image characteristics comprises a contrast percentage, a brightness percentage, a tissue contrast parameter, an edge parameter, or a combination thereof

6. The method of claim 1, comprising transmitting data corresponding to the demonstration image library to a second X-ray imaging system.

7. The method of claim 1, wherein the X-ray imaging system comprises a digital radiography system, a fluoroscopy system, or a combination thereof

8. The method of claim 1, comprising receiving data corresponding to a manufacturer provided demonstration image and adding the manufacturer provided demonstration image to the demonstration image library as a second demonstration image.

9. A medical imaging system, comprising:
an imager configured to acquire image data indicative of a region of interest in a subject;
an operator interface configured to receive a user selection corresponding to an image of the subject acquired with the imager and desired as a demonstration image; and
control circuitry communicatively coupled to the operator interface and the imager, the control circuitry being configured to receive data corresponding to the image of the subject selected by the user and to add the user acquired image of the subject to a demonstration image library as a first demonstration image.

10. The system of claim 9, wherein the control circuitry is further configured to receive user input corresponding to one or more desired image characteristics for the first demonstration image, and to replace the first demonstration image in the demonstration image library with an adjusted demonstration image having the one or more desired image characteristics defined by the user.

11. The system of claim 10, wherein the control circuitry is further configured to transmit the adjusted demonstration image to a picture archiving communication system (PACS).

12. The system of claim 10, wherein the one or more desired image characteristics comprises a contrast percentage, a brightness percentage, a tissue contrast parameter, an edge parameter, or a combination thereof

13. The system of claim 9, wherein the control circuitry comprises memory configured to store the demonstration image library.

14. The system of claim 9, wherein the demonstration image library comprises one or more manufacturer provided demonstration images.

15. The system of claim 9, wherein the imager comprises a digital X-ray device, a fluoroscopy device, or a combination thereof

16. The system of claim 9, wherein the control circuitry is communicatively coupled to a controller associated with a second medical imaging system and is configured to transmit data corresponding to the demonstration image library to the controller.

17. A medical imaging system, comprising:
an operator interface configured to receive a user selection corresponding to a user acquired image of a subject obtained via operation of an X-ray imaging system and desired as a demonstration image;
control circuitry communicatively coupled to the operator interface and configured to receive data corresponding to the image of the subject selected by the user and to add the user acquired image of the subject to a demonstration image library as a first demonstration image; and
a picture archiving communication system (PACS) configured to receive data corresponding to the first demonstration image and to display the first demonstration image.

18. The system of claim 17, wherein the operator interface is further configured to receive user input corresponding to one or more desired image characteristics for the first demonstration image, and to replace the first demonstration image in the demonstration image library with an adjusted demonstration image having the one or more desired image characteristics defined by the user.

19. The system of claim 18, wherein the PACS is further configured to receive data corresponding to the adjusted demonstration image and to display the adjusted demonstration image.

20. The system of claim 18, wherein the one or more desired image characteristics comprises a contrast percentage, a brightness percentage, a tissue contrast parameter, an edge parameter, or a combination thereof

21. The system of claim 17, wherein the control circuitry is communicatively coupled to a controller associated with a second X-ray imaging system and is configured to receive data from the controller corresponding to a second user acquired image acquired via operation of the second X-ray imaging system, and to add the second user acquired image of the subject to the demonstration image library as a second demonstration image.
